(19) United States
(12) Patent Application Publication
(10) Pub. No.: US 2008/0165667 A1
(43) Pub. Date: Jul. 10, 2008

(54) METHOD AND APPARATUS FOR DISCRIMINATING OPTICAL INFORMATION STORAGE MEDIA

(75) Inventors: Tatsuhiro OTSUKA, Suwon-si (KR); Kyung-geun LEE, Seongnam-si (KR); Young-jae PARK, Yongin-si (KR); Sung-Hyun KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/835,703

(22) Filed: Aug. 8, 2007

(30) Foreign Application Priority Data
Jan. 5, 2007 (KR) 2007-1708

(51) Int. Cl. G11B 7/24

(52) U.S. Cl. 369/275.1

(57) ABSTRACT

A method of discriminating an optical information storage medium. The method includes generating a signal obtained by summing the amount of light reflected by the optical information storage medium and received by a quadrant photodetector by moving an objective lens up and down at a predetermined speed while the optical information storage medium is loaded, outputting a first signal generated by comparing the sum signal with a first slice level, outputting a second signal generated by passing the sum signal through a band pass filter, outputting a third signal generated by comparing the second signal with a second slice level, outputting a fourth signal generated by performing an operation with respect to the first signal and the third signal, and determining the number of data layers of the optical information storage medium based on the fourth signal.

### CROSS-REFERENCE TO RELATED APPLICATIONS

This application claims the benefit of Korean Patent Application No. 2007-1708, filed in the Korean Intellectual Property Office on Jan. 5, 2007, the disclosure of which is incorporated herein by reference.

### BACKGROUND OF THE INVENTION

1. Field of the Invention

Aspects of the present invention relate to a method and apparatus for discriminating multilayer optical information storage media having at least 2 layers and, more particularly, to a method and apparatus for discriminating the number of layers of an optical information storage medium by detecting the overall thickness of data layers.

2. Description of the Related Art

Optical discs capable of recording a large amount of data are widely used as optical information storage media. New high density optical recording media are currently being developed, such as the Blu-ray disc, which can record and store high quality video data and high quality audio data for a long time.

The Blu-ray disc is one of the next generation technologies. The Blu-ray disc is an optical recording solution that can store a relatively large amount of data compared to a conventional DVD (digital versatile disc). The Blu-ray disc can store 25 GB of data on a single side. A dual disc capable of storing 50 GB of data in dual layers is also commercially available. A high density multilayer disk capable of storing 100 GB of data or more is being developed.

FIG. 1 illustrates the structure of a dual-layer disc having two layers. FIG. 1 illustrates the structure of a dual-layer Blu-ray disc which is a high density disc having a high NA of 0.85 and a wavelength of 405 nm. As shown in FIG. 1, when the section of the disc is viewed vertically, Surface Layer, Cover Layer, Data Layer L1, Spacer Layer, Data Layer L0, and Substrate are sequentially stacked on and above a surface on which a light beam is incident. While the total thickness of the disk is 1.2 mm, the Cover Layer, the Spacer Layer, and the Substrate are respectively 75 μm, 25 μm, and 1.1 mm thick. Various data are recorded on the Data Layers L1 and L0 of the optical disc.

FIG. 2 illustrates the structure of a multilayer Blu-ray disc in which the number of data layers is increased to increase the storage capacity of the Blu-ray disc having a capacity of 25 GB on a single side higher than that of the dual-layer disc. Compared to the multilayer disc of FIG. 1, the Spacer Layer is formed of a plurality of layers delta_1, . . . , delta_n, and accordingly a plurality of data layers Data Layer Ln-1, . . . , Data Layer L0 are provided.

In the multilayer disc shown in FIG. 2, like the dual-layer disc of FIG. 1, Surface Layer, Cover Layer, Data Layer Ln-1, Spacer Layer, Data Layer Ln-2, Spacer Layer, . . . , Data Layer L0, and Substrate are sequentially stacked on and above a surface on which a light beam is incident. A method of optimizing the thickness between layers and the reflectance of each layer to minimize an interference phenomenon between the Data Layers has been developed. In a general multilayer structure, the interference is minimized when the thickness of the Spacer Layer is set between 10 μm and 25 μm.

The position of the lowest Data Layer Ln-1 of the multilayer disc of FIG. 2 is lower than that of the lowest Data Layer L1 of the dual-layer disc of FIG. 1. The position of the highest Data Layer L0 of the multilayer disc of FIG. 2 is higher than that of the highest Data Layer L0 of the dual-layer disc of FIG. 1. To correspond to the types of discs having different physical characteristics according to the thickness of the discs, disc compatibility can be improved through an optical disc discrimination process called Detect Disc Type (DDT). The discrimination of the optical disc indicates whether an optical disc loaded in an optical information storage medium recording/reproducing apparatus is a high or low density disc, a reproduction dedicated disc or rewritable disc, and/or a single layer or multilayer disc.

The determination of the number of layers of the disc is particularly important, since the determination of the number of layers of a disc needs to undergo an automatic adjustment process for loading and optimizing basic settings for each layer to fit to an optical disc in relation to a servo error signal of an RF amplifier. It is important to reduce disc discrimination performance time so as to reduce the lead-in time of a disc.

FIG. 3 illustrates the method of discriminating an optical disc according to the conventional technology. When an optical disc is loaded in an optical information storage medium recording and/or reproducing apparatus, an objective lens is moved perpendicularly to the optical disc and a signal is measured from the amount of light reflected from the optical disc and received by a quadrant photodetector (shown in FIG. 4A or 4B) so that the type of the optical disc is determined. The quadrant photodetector has regions A, B, C, and D counterclockwise. A radio frequency direct current (RFDC) signal of a focus error signal (FES) is generated from information on the amount of light incident on each of the regions A, B, C, and D of the quadrant photodetector.

The position of the objective lens is moved according to a focus drive signal (FOD). The position where the focus of a light beam is formed is determined according to the movement of the objective lens. When the position of the objective lens moves upward, the position of the focus of the light beam moves upward. When the position of the objective lens moves downward, the position of the focus of the light beam moves downward. The RF amplifier calculates the light input from the quadrant photodetector in an astigmatism method ((A+C)-(B+D)) and outputs a focus error signal FES. The RF amplifier sums the light input from the quadrant photodetector (A+C+B+D) and outputs an RFDC signal corresponding to a total sum signal.

FIG. 4A illustrates the shape of light received by a quadrant photodetector when a light beam is accurately focused on a data layer. FIG. 4B illustrates the shape of light received by a quadrant photodetector when a light beam is not accurately focused on a data layer. First, when a light beam passing through an objective lens is accurately focused on the Data Layer L1 and Data Layer L0, the light received by the quadrant photodetector is formed with the same size in each of the regions A, B, C, and D, as shown in FIG. 4A. At this point, a focus error signal (FES) is 0 and the RFDC signal has the maximum value according to an astigmatism method. As shown in FIG. 3, when the focus of the light beam is accurately formed on the Data Layer L1 and Data Layer L0, the FES is 0 and the RFDC signal has the maximum value according to an astigmatism method.

When the focus of the light beam passing through an objective lens is not accurately formed on the Data Layer L1 and Data Layer L0, the light received by the quadrant photodetector is formed with an irregular size in each of the regions A, B, C, and D, as shown in FIG. 4B. Thus, as shown in FIG. 3, when the position at which the focus of the light beam is formed approaches the Data Layer L1 and Data Layer L0, the FES has a positive level value, and when the position at which the focus of the light beam is formed is separated from the Data Layer L1 and Data Layer L0, the FES has a negative level value. The FES has an S-curve shape based on the Data Layer L1 and Data Layer L0. The RFDC signal has a parabolic shape based on the Data Layer L1 and Data Layer L0. For the surface layer, since the amount of reflection is small, the level variation range of the FES and RFDC signals is small.

When the FES shifts from a value higher than a positive level to a value lower than a negative level during the upward or downward movement of the objective lens, a layer count signal by the FES alternately indicates a positive pulse and a negative pulse. When the FES shifts from a value lower than a negative level to a value higher than a positive level, the layer count signal by the FES alternately indicates a negative pulse and a positive pulse. The number of layers of the data layers can be determined by counting the number of changes that the layer count signal by the FES shifts from the positive pulse to the negative pulse or vice versa.

As shown in FIG. 3, during the upward and downward movement of the objective lens, when the RFDC signal is higher than a set first slice level, the layer count signal by the RFDC becomes a high level. The number of the data layers is determined by the number of shifts to a high level.

During the upward movement of the objective lens, when the first section in which the RFDC signal satisfies a value greater than a second slice level, the layer is determined to be the surface layer. When the detection of the surface layer is complete, the objective lens is continuously moved upward. As the objective lens moves upward, when a section in which the RFDC signal satisfies a value greater than the first slice level, the layer is determined to be the data layer. When the discrimination of the data layer in this manner is complete, the objective lens is moved downward. As shown in FIG. 3, the first slice level is used to discriminate the data layer and the second slice level having a value lower than the first slice level is used to discriminate the surface layer.

Since the thicknesses of the cover layer and the spacer layer vary according to the specification of the optical disc, a spherical aberration phenomenon in which a signal is distorted due to the difference in thickness can be generated. To prevent this phenomenon, the optical information storage medium recording/reproducing apparatus separately corrects the spherical aberration. To compensate for a difference in thickness between layers of the optical disc, the correction of the spherical aberration is performed by focusing a light beam on one of a plurality of data layers and then on other data layer based on the previously focused light beam.

However, in the conventional technology, in the discrimination of the number of the data layers of the optical disc using the FES and RFDC signals, since the layer count signal is unclear according to the position of the spherical aberration correction, there are some cases in which the number of data layers is incorrect.

FIG. 5 illustrates an example in which an error is generated in the counting of the number of data layers according to the conventional technology. When the spherical aberration correction is performed based on the Data layer L0, the amount of reflection of a light beam by the Data layer L1 decreases so that the magnitude of the FES and RFDC signals decrease. Thus, both a layer count signal by the FES and a layer signal by the RFDC become a low level with respect to the Data Layer L1, and the Data Layer L1 is not counted accurately.

FIG. 6 illustrates another example in which an error is generated in the counting of the number of data layers according to the conventional technology. There may be a case in which a distorted signal is counted between the surface layer and Data Layer L1 according to the set level of the positive level and negative level of the FES.

As described above, the conventional method of discriminating the number of layers of a disc having a plurality of data layers is disadvantageous in that, even when spherical aberration is set at the Data Layer L1, the Data Layer L0, and an intermediate position between the Data Layer L1 and the Data layer L0, the determination of the number of layers is incorrect because of the signal distortion phenomenon and the imbalance in level between the positive value and the negative value of the FES.

In particular, according to the conventional technology, as the number of the data layers of the optical disc increases, the signal is more deteriorated due to the interlayer interference phenomenon so that the discrimination of the number of the data layers becomes more incorrect.

### SUMMARY OF THE INVENTION

Aspects of the present invention provide a method and apparatus for discriminating the number of data layers of an optical disc having a multilayer structure in an optical disc recording and/or reproducing apparatus.

According to an aspect of the present invention, a method of discriminating an optical information storage medium of an optical information storage medium recording and/or reproducing apparatus is provided. The method comprises generating a signal by summing the amount of light reflected by the optical information storage medium and received by a photodetector by moving an objective lens up and down at a predetermined while the optical information storage medium is loaded, outputting a first signal generated by comparing the sum signal with a first slice level, outputting a second signal generated by passing the sum signal through a band pass filter, outputting a third signal generated by comparing the second signal with a second slice level, outputting a fourth signal generated by performing an operation based on the first signal and the third signal, and discriminating the number of data layers of the optical information storage medium based on the fourth signal.

According to another aspect of the present invention, the operation is an AND operation.

According to another aspect of the present invention, the first slice level is higher than the second slice level.

According to another aspect of the present invention, the method further comprises correcting a spherical aberration of the optical information storage medium corresponding to a result of the determination of the data layers of the optical information storage medium.

According to another aspect of the present invention, the optical information storage medium has a wavelength of 405 nm or more and a high NA of 0.85 or more.

According to another aspect of the present invention, the first signal becomes a high level when the sum signal has a value higher than the first slice level and the third signal becomes a high level when the second signal has a value higher than the second slice level.

According to another aspect of the present invention, a method of discriminating an optical information storage medium of an optical information storage medium recording and/or reproducing apparatus is provided. The method comprises generating a signal obtained by summing the amount of light reflected by the optical information storage medium and received by a photodetector by moving an objective lens up and down at a predetermined speed while the optical information storage medium is loaded in the recording and/or reproducing apparatus, outputting a first signal generated by passing the sum signal through a band pass filter, outputting a second signal generated by comparing the first signal with a slice level, and determining the number of data layers of the optical information storage medium based on the second signal.

According to another aspect of the present invention, the second signal becomes a high level when the first signal has a value higher than the slice level.

According to another aspect of the present invention, an optical information storage medium recording and/or reproducing apparatus is provided. The apparatus comprises an optical pickup unit to move an objective lens up and down at a predetermined speed to allow light reflected by a loaded optical information storage medium to be received by a photodetector; an RF amplification unit to output a signal obtained by summing the amount of the received light; a data layer discrimination unit to generate a first signal by comparing the sum signal with a first slice level, to generate a second signal based on the sum signal, to generate a third signal by comparing the second signal with a second slice level, to generate a fourth signal by performing an operation with respect to the first and third signals, and to determine the number of data layers of the optical information storage medium based on the first through fourth signals.

According to another aspect of the present invention, the data layer discrimination unit comprises a first slice processing unit to output the first signal, which becomes a high level when the sum signal has a value higher than the first slice level, a band pass filter to generate the second signal from the sum signal, a second slice processing unit to output a third signal that becomes a high level when the second signal has a value higher than the second slice level, a logic operation unit having a non-inverse terminal and an inverse terminal to which the first signal and the third signal are input, to perform the operation on the first and third signals and to output a fourth signal, and a counter to determine the number of data layers of the optical information storage medium based on the fourth signal.

According to another aspect of the present invention, the logic operation unit is an AND gate.

According to another aspect of the present invention, the counter determines the number of the data layers of the optical information storage medium through the number of high levels of the fourth signal.

According to another aspect of the present invention, the apparatus further comprises a spherical aberration correction unit to output to the optical pickup unit a signal correcting spherical aberration of the optical information storage medium based on a result of the determination of the data layers of the optical information storage medium.

According to another aspect of the present invention, an optical information storage medium recording and/or reproducing apparatus is provided. The apparatus comprises an optical pickup unit to move an objective lens up and down at a predetermined speed to allow light reflected by a loaded optical information storage medium to be received by a photodetector; an RF amplification unit to output a signal obtained by summing the amount of the received light; a data layer discrimination unit to generate a first signal based on the sum signal, to generate a second signal by comparing the first signal with a slice level, and to determine the number of data layers of the optical information storage medium based on the second signal.

According to another aspect of the present invention, the data layer discrimination unit comprises a slice processing unit to generate and to output the first signal, which becomes a high level when the sum signal has a value higher than the first slice level, a band pass filter to generate the second signal based on the sum signal, and a counter to determine the number of data layers of the optical information storage medium based on the second signal.

According to another aspect of the present invention, the counter determines the number of data layers of the optical information storage medium through the number of high levels of the second signal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structure of a dual-layer disc having two layers;

FIG. 2 illustrates the structure of a multilayer disc having multiple layers;

FIG. 3 illustrates the method of discriminating an optical disc according to the conventional technology;

FIG. 4A illustrates the shape of light received by a quadrant photodetector when a light beam is accurately focused on a data layer;

FIG. 4B illustrates the shape of light received by a quadrant photodetector when a light beam is not accurately focused on a data layer;

FIG. 5 illustrates an example in which an error is generated in the counting of the number of data layers according to the conventional technology;

FIG. 6 illustrates another example in which an error is generated in the counting of the number of data layers according to the conventional technology;

FIG. 7 illustrates the structure of an optical disc recording and/or reproducing apparatus according to an embodiment of the present invention;

FIG. 8 illustrates the structure of an optical pickup unit according to an embodiment of the present invention;

FIG. 9 illustrates the structure of a data layer discrimination unit according to an embodiment of the present invention;

FIGS. 10A-10E illustrate the signals output from the respective parts of the data layer discrimination unit of FIG. 9;

FIG. 11 illustrates the RFDC signal and the BPF output signal according to an embodiment of the present invention; and

FIG. 12 illustrates the structure of a data layer discrimination unit according to another embodiment of the present invention.

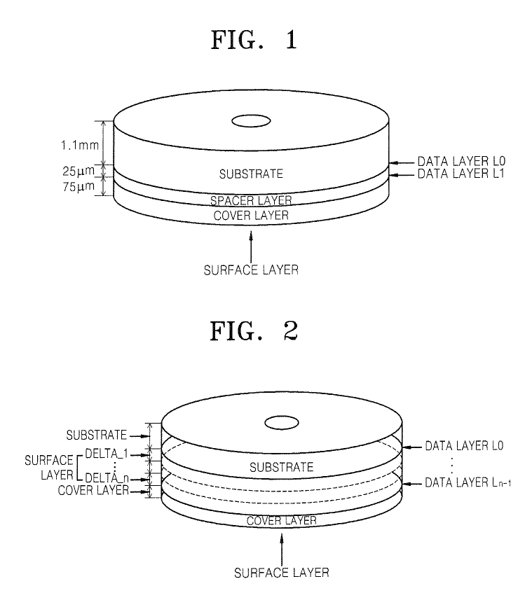

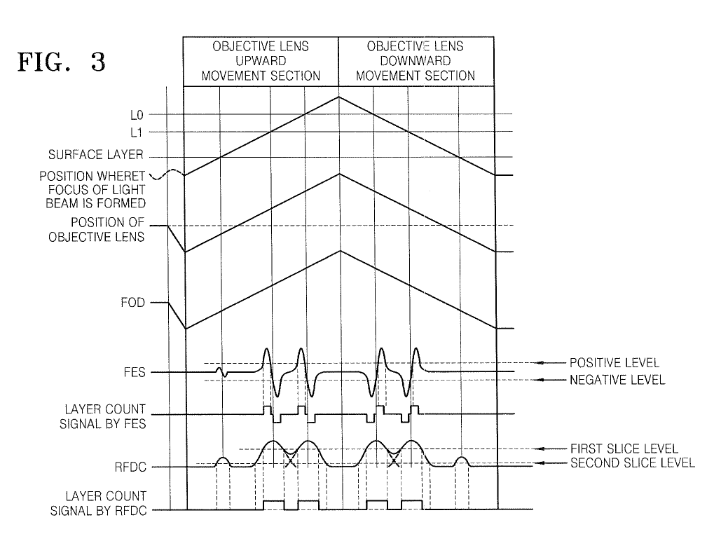

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

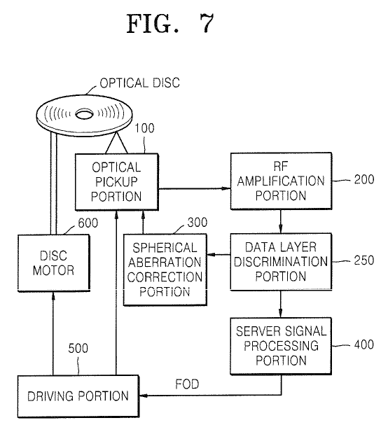

FIG. 7 illustrates the structure of an optical disc recording and/or reproducing apparatus according to an embodiment of the present invention. The optical disc recording and/or reproducing apparatus includes an optical pickup unit 100, an RF amplification unit 200, a data layer discrimination unit 250, a spherical aberration correction unit 300, a servo signal processing unit 400, a driving unit 500, and a disc motor 600. The optical disc recording and/or reproducing apparatus according to other aspects of the present invention may include different units or may incorporate one or more of the above units into a single component.

The optical pickup unit 100 is driven by a tracking actuator for tracking servo control and by a focus actuator for focus servo control, and converts a received light beam to an electric RF signal by emitting light onto the optical disc. The optical pickup unit 100 optically picks up information recorded on the optical disc, converts the picked up information to an electric RF signal, and outputs the converted RF signal to the RF amplification unit 200.

The RF amplification unit 200 amplifies the RF signal output from the optical pickup unit 100. The RF amplification unit 200 calculates the light output from a quadrant photodetector included in the optical pickup unit 100 using an astigmatism method ((A+C)-(B+D)), outputs a focus error signal (FES), sums the light output from the quadrant photodetector (A+B+C+D), and outputs an radio frequency direct current (RFDC) signal corresponding to the total sum signal.

The data layer discrimination unit 250 discriminates data layers of a loaded optical disc using the RFDC signal output from the RF amplification unit 200 and outputs the RFDC signal to the spherical aberration correction unit 300 to compensate for the spherical aberration of the optical disc. The process of the compensation will be described in detail with reference to FIGS. 9 through 12.

The spherical aberration correction unit 300 focuses a light beam on one of the data layers and then on the other data layer based on the above focusing to compensate for the difference in thickness between the layers of the optical disc. The servo signal processing unit 400 receives the FES, the RFDC signal, and a layer detection signal from the data layer discrimination unit 250. The servo signal processing unit 400 outputs a focus drive signal (FOD) so that an objective lens moves up and down in a vertical direction of the optical disc, to thus control the position of the focus of the light beam.

The driving unit 500 includes a focus actuator (not shown) and a focus drive (not shown) and drives the focus actuator according to the FOD output from the servo signal processing unit 400, to thus move the objective lens up and down in the vertical direction of the optical disc. The disc motor 600 rotates the optical disc in a constant linear velocity (CLV) method or a constant angular velocity (CAV) method using a disc driving signal output from the driving unit 500.

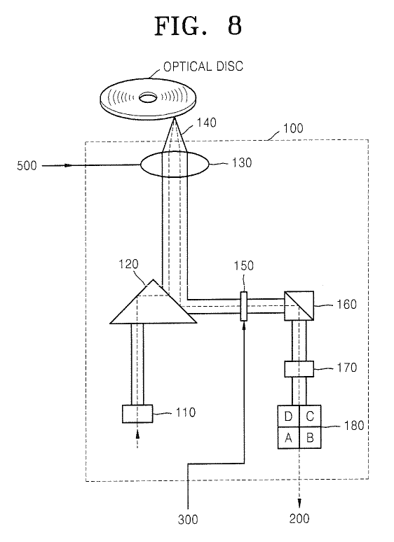

FIG. 8 illustrates the structure of the optical pickup unit 100 according to an embodiment of the present invention. The optical pickup unit 100 includes a laser diode (LD) 110, a reflection mirror 120, an objective lens 130, a light beam 140, a collimator lens 150, a beam splitter 160, a focus lens 170, and a quadrant photodetector 180.

When the LD 110 is in an “ON” state, the light emitted by the LD 110 is reflected by the reflection mirror 120 and incident on the optical disc. The light output from the objective lens 130 is incident on the optical disc through the light beam 140. The reflected light passes through the collimator lens 150 and is split by the beam splitter 160. The spherical aberration compensation unit 300 transmits a signal to the collimator lens 150 to compensate for spherical aberration generated according to the thickness of the optical disc. The collimator lens 150 moves to the left and right and adjusts the position of a focus on the optical disc.

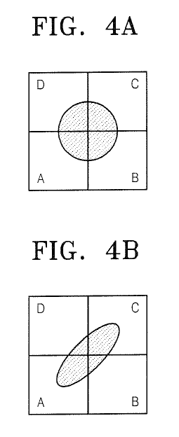

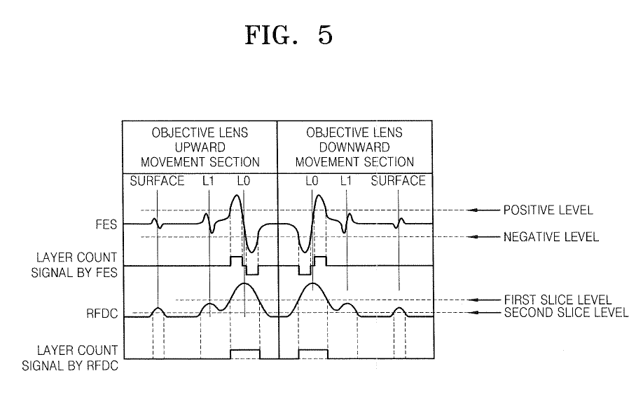

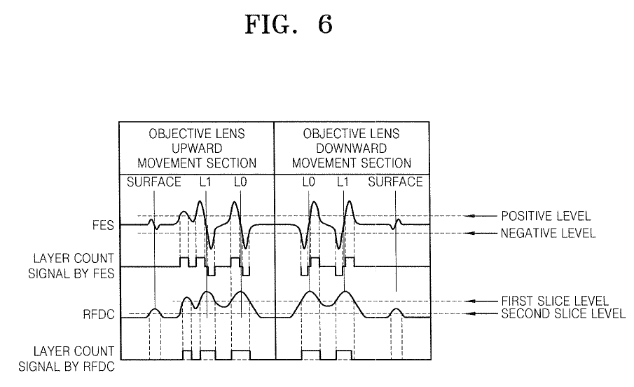

The light split by the beam splitter 160 is focused by the focusing lens 170. The focused light is transmitted to the quadrant photodetector 180. The quadrant photodetector 180 transmits the amount of the light incident on the regions A, B, C, and D, as shown in FIGS. 4A and 4B. The RF amplification unit 200 calculates the light received from the quadrant photodetector in the astigmatism method and generates a focus error signal (FES). The RF amplification unit 200 also sums the light received from the quadrant photodetector (A+B+C+D), generates the RFDC signal, and outputs the FES and the RFDC signals to the servo signal processing unit 400.

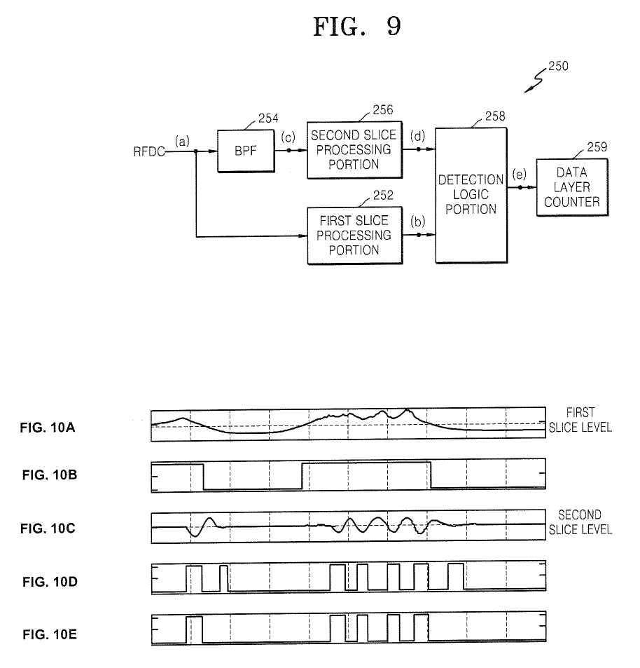

A technique of determining the number of data layers of an optical disc loaded in the present system using the data layer discrimination unit 250 will be described with reference to FIGS. 9 through 12. FIG. 9 illustrates the structure of the data layer discrimination unit 250 according to an embodiment of the present invention. FIG. 10 illustrates the signals output from the respective parts of the data layer discrimination unit 250 of FIG. 9.

As shown in FIG. 9, the data layer discrimination unit 250 includes a first slice processing unit 252, a band pass filter (BPF) 254, a second slice processing unit 256, a detection logic unit 258, and a data layer counter 259. The data layer discrimination unit 250 according to other aspects of the invention may include different units; similarly, one or more of the above units may be integrated into a single component.

First, at a point (a) of FIG. 9, the objective lens moves upward in a vertical direction toward the optical disc to detect the RFDC signal as shown in FIG. 10A. It is understood that the objective lens 130 moves toward and/or away from the optical disc, which may correspond to various directions depending on the orientation of the optical disc. When the RFDC signal is input to the first slice processing unit 252, the first slice processing unit 252 compares the RFDC signal with the first slice level as shown in FIG. 10B. When the RFDC signal has a value higher than the first slice level, a window signal has a high level, as shown in FIG. 10B. The high level shown in FIG. 10B may be referred to as a first state, and it is understood that according to other aspects of the invention, the window signal may have a low level and the first state may correspond to the low level (such as if the RFDC signal is inverted.) The signal detected at a point (b) of FIG. 9 after passing through the first slice processing unit 252 becomes the signal shown in FIG. 10B.

The BPF 254 allows only a frequency component corresponding to the peak of the RFDC signal and amplifies a passed result value. Thus, at a point (c) of FIG. 9, when the RFDC signal is BPF-processed, a BPF output signal is extracted, as shown in FIG. 10C.

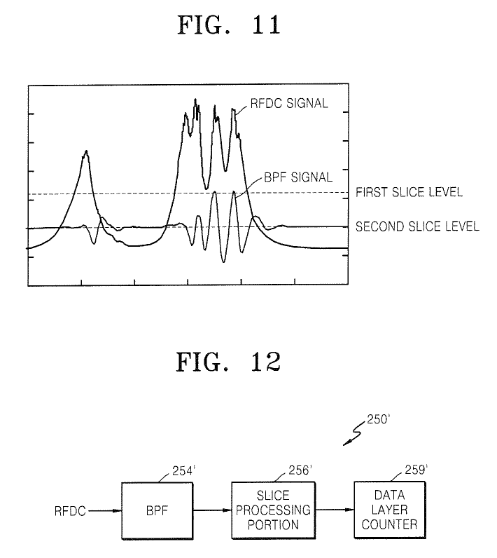

FIG. 11 is an enlarged illustration of the RFDC signal and the BPF output signal according to an embodiment of the present invention. When the RFDC signal is BPF-processed, a frequency component corresponding to the peak of the RFDC signal is extracted. Since technologies related to the BPF 254 are well known to those skilled in the art, a detailed description of the BPF 254 will be omitted.

The second slice processing unit 256 receives the BPF output signal and compares the BPF output signal with the second slice level, as shown in FIG. 10C. When the BPF output signal has a value higher than the second slice level, a layer counter signal according to the BPF output signal has a high level, as shown in FIG. 10D. The BPF output signal is binarized and a signal detected at a point (d) of FIG. 9 after passing through the second slice processing unit 256 is as shown in FIG. 10D.

When the window signal of FIG. 10B and the layer count signal according to the BPF output signal of FIG. 10D are input, the detection logic unit 258 calculates the two signals and outputs a final layer detection signal. The signal detected at a point (e) of FIG. 9 output from the detection logic unit 258 is as shown in FIG. 10E.

The detection logic unit 258 performs an AND operation with respect to the window signal of FIG. 10B and the layer count signal according to the BPF output signal of FIG. 10D and outputs the layer detection signal, shown in FIG. 10E. The data layer counter 259 determines from the number of high levels of the layer detection signal that the number of the data layers of the loaded optical disc is four. When the objective lens 130 moves upward, the data layer counter 259 determines the first high level signal of the layer detection signal to be the surface layer. When the objective lens 130 moves downward, the data layer counter 259 determines the final high level signal of the layer detection signal to be the surface layer.

As the window signal and the layer count signal according to the BPF output signal are AND-operated, reliability is improved as compared to determining the number of data layers using only one of the above two signals. As shown in FIG. 11, the first slice level is generally set higher than the second slice level. This allows a more accurate determination of the data layers of the optical disc.

When the data layer discrimination unit 250 determines the number of data layers of the loaded optical disc, the position of spherical aberration is moved corresponding to the data layer with respect to the data layer of the optical disc by the spherical aberration correction unit 300. The RF amplification unit 200 resets an RF amplification value.

Also, according to the present embodiment, even when the discrimination of the data layer is difficult as the effect of spherical aberration is high as in an optical disc having data reproducible by light at a wavelength of 405 nm or more and a high NA of 0.85 or more, discriminating the data layers of the optical disc has a high accuracy.

FIG. 12 illustrates the structure of a data layer discrimination unit 250′ according to another embodiment of the present invention. The data layer discrimination unit 250′ includes a BPF 254′, a slice processing unit 256′, and a data layer counter 259′. Unlike the previous embodiment, the BPF 254′ passes only a frequency component of the RFDC signal corresponding to the peak of the RFDC signal, amplifies the passed value, and generates the BPF output signal. The slice processing unit 256′ outputs a layer discrimination signal which becomes a high level when the BPF output signal has a value higher than the second slice level. The data layer counter 259′ discriminates the number of the data layer of the loaded optical disc from the number of high levels of the layer discrimination signal.

The slice processing unit 256′ can accurately recognize the number of data layers by adjusting the slice level. Compared to the first embodiment, the present embodiment has an advantage of simplifying the structure of the data layer discrimination unit. The same descriptions as those in the first embodiment will be omitted. Although it is not shown, a detection logic unit is further connected after the slice processing unit 256′ to more accurately recognize the number of data layers.

As described above, in the technique of discriminating an optical information storage medium of an optical information storage medium recording/reproducing apparatus according to aspects of the present invention, since the RFDC signal generated when the objective lens is moved up and down with respect to a multilayer optical disc is BPF processed, accuracy is improved in discriminating the number of data layers and compatibility for different optical information storage media is improved.

Techniques of discriminating layers of optical information storage medium according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of discriminating an optical information storage medium of an optical information storage medium recording and/or reproducing apparatus, the method comprising:
generating a sum signal by summing the amount of light reflected by the optical information storage medium and received by a photodetector by moving an objective lens toward or away from the optical information storage medium at a predetermined speed while the optical information storage medium is loaded in the optical information storage medium recording and/or reproducing apparatus;
outputting a first signal generated by comparing the sum signal with a first slice level;
outputting a second signal generated by passing the sum signal through a band pass filter;
outputting a third signal generated by comparing the second signal with a second slice level;
outputting a fourth signal generated by performing an operation based on the first signal and the third signal; and
determining the number of data layers of the optical information storage medium based on the fourth signal.

2. The method of claim 1, wherein the operation is an AND operation.

3. The method of claim 2, wherein the first slice level is higher than the second slice level.

4. The method of claim 1, further comprising correcting a spherical aberration of the optical information storage medium corresponding to a result of the determination of the data layers of the optical information storage medium.

5. The method of claim 1, wherein the first signal becomes a high level when the sum signal has a value higher than the first slice level and the third signal becomes a high level when the second signal has a value higher than the second slice level.

6. A method of discriminating an optical information storage medium of an optical information storage medium recording and/or reproducing apparatus, the method comprising:
generating a sum signal obtained by summing the amount of light reflected by the optical information storage medium and received by a photodetector by moving an objective lens toward or away from the optical information storage medium at a predetermined speed while the optical information storage medium is loaded in the recording and/or reproducing apparatus;
outputting a first signal generated by passing the sum signal through a band pass filter;
outputting a second signal generated by comparing the first signal with a slice level; and
determining the number of data layers of the optical information storage medium based on the second signal.

7. The method of claim 6, wherein the second signal becomes a high level when the first signal has a value higher than the slice level.

8. The method of claim 6, further comprising correcting a spherical aberration of the optical information storage medium based on the determination of the data layers of the optical information storage medium.

9. An optical information storage medium recording and/or reproducing apparatus comprising:
an optical pickup unit to move an objective lens toward or away from the optical information storage medium at a predetermined speed to allow light reflected by the loaded optical information storage medium to be received by a photodetector;
an RF amplification unit to output a sum signal obtained by summing the amount of the received light;
a data layer discrimination unit to generate a first signal by comparing the sum signal with a first slice level, to generate a second signal based on the sum signal, to generate a third signal by comparing the second signal with a second slice level, to generate a fourth signal by performing an operation on the first and third signals, and to determine the number of data layers of the optical information storage medium based on the first through fourth signals.

10. The apparatus of claim 9, wherein the data layer discrimination unit comprises:
a first slice processing unit to output the first signal, which becomes a high level when the sum signal has a value higher than the first slice level;
a band pass filter to generate the second signal based on the sum signal;
a second slice processing unit to output a third signal that becomes a high level when the second signal has a value higher than the second slice level;
a logic operation unit having a non-inverse terminal and an inverse terminal to which the first signal and the third signal are input, to perform the operation on the first and third signals and to output the fourth signal; and
a counter to determine the number of data layers of the optical information storage medium based on the fourth signal.

11. The apparatus of claim 10, wherein the logic operation unit is an AND gate.

12. The apparatus of claim 10, wherein the first slice level is higher than the second slice level.

13. The apparatus of claim 10, wherein the counter determines the number of the data layers of the optical information storage medium through the number of high levels of the fourth signal.

14. The apparatus of claim 9, further comprising a spherical aberration correction unit to output to the optical pickup unit a signal correcting a spherical aberration of the optical information storage medium based on a result of the determination of the data layers of the optical information storage medium.

15. An optical information storage medium recording and/or reproducing apparatus comprising:
an optical pickup unit to move an objective lens toward or away from an optical information storage medium at a predetermined speed to allow light reflected by the optical information storage medium to be received by a photodetector;
an RF amplification unit to output a sum signal obtained by summing the amount of the received light;
a data layer discrimination unit to generate a first signal based on the sum signal, to generate a second signal by comparing the first signal with a slice level, and to discriminate the number of data layers of the optical information storage medium based on the second signal.

16. The apparatus of claim 15, wherein the data layer discrimination unit comprises:
a slice processing unit to generate and to output the first signal, which becomes a high level when the sum signal has a value higher than the slice level;
a band pass filter to generate the second signal based on the sum signal; and
a counter to determine the number of data layers of the optical information storage medium based on the second signal.

17. The apparatus of claim 16, wherein the counter discriminates the number of data layers of the optical information storage medium through the number of high levels of the second signal.

18. The apparatus of claim 15, further comprising a spherical aberration correction unit to output to the optical pickup unit a signal correcting a spherical aberration of the optical information storage medium corresponding to a result of the determination of the data layers of the optical information storage medium.
